(19) United States
(12) Patent Application Publication
(10) Pub. No.: US 2017/0082110 A1
(43) Pub. Date: Mar. 23, 2017

(54) SYSTEM AND METHOD FOR FRACTURING FORMATIONS IN BORES

(71) Applicant: Caterpillar Inc., Peoria, IL (US)

(72) Inventor: Bryan G. Lammers, Peoria Heights, IL (US)

(73) Assignee: Caterpillar Inc., Peoria, IL (US)

(21) Appl. No.: 14/859,848

(22) Filed: Sep. 21, 2015

(51) Int. Cl. F04D 3/02; F04D 29/043; F04D 29/52; E21B 43/26; F04D 13/04

(52) U.S. Cl. CPC F04D 3/02; E21B 43/26; F04D 13/04; F04D 29/528; F04D 29/043; F05D 2220/30

(57) ABSTRACT

A system for fracturing a formation in a bore at a worksite is disclosed. The system includes a turbine. The system also includes a pump coupled to the turbine. The pump includes a housing member that is adapted to receive a fracturing fluid. The pump also includes an auger rotatably disposed within the housing member. The auger pressurizes the fracturing fluid at a desired pressure based on a speed of the turbine to supply a pressurized fracturing fluid to the bore. The auger includes a shaft coupled to the turbine and rotatable about a rotational axis. The auger also includes a helical blade disposed around the shaft.

### TECHNICAL FIELD

The present disclosure relates to a system and a method for fracturing a formation in a bore, and more particularly to a system and method for fracturing a formation by supplying a pressurized fracturing fluid to the bore.

### BACKGROUND

Fracturing rigs that are currently available in the market include a number of components, such as an engine, an aftertreatment system and a cooling system associated with the engine, a drive shaft, a transmission system and a fracturing pump. These components are large, bulky, and expensive. Further, some of these components have a short service life, due to which they require periodic replacements. Periodic replacements of these components may cause considerable downtime and compensation during fracturing process, thereby increasing cost associated with the operation of the fracturing rig.

U.S. Pat. No. 7,845,413, hereinafter referred to as the '413 patent, describes splitting a fracturing fluid stream into a clean stream having a minimal amount of solids and a dirty stream having solids in a fluid carrier. The clean stream is pumped from a well surface to a wellbore by one or more clean pumps and the dirty stream is pumped from the well surface to the wellbore by one or more dirty pumps. However, the system used for pumping the fracturing fluid stream described in the '413 patent includes a number of components that increase complexity of the system. Also, the components of the disclosed system are bulky and expensive, thereby increasing overall cost associated with a pumping operation.

### SUMMARY OF THE DISCLOSURE

In one aspect of the present disclosure, a system for fracturing a formation in a bore at a worksite is provided. The system includes a turbine. The system also includes a pump coupled to the turbine. The pump includes a housing member configured to receive a fracturing fluid. The pump also includes an auger rotatably disposed within the housing member. The auger is configured to pressurize the fracturing fluid at a desired pressure based on a speed of the turbine to supply a pressurized fracturing fluid to the bore. The auger includes a shaft coupled to the turbine and rotatable about a rotational axis. The auger also includes a helical blade disposed around the shaft.

In another aspect of the present disclosure, a method for fracturing a formation in a bore defined at a work site is provided. The method includes rotating a rotor shaft of a turbine to rotate a shaft of a pump connected to the turbine. The pump includes a housing member and an auger rotatably disposed within the housing member. The method also includes receiving a fracturing fluid with the housing member. The method further includes controlling a speed of the turbine to pressurize the fracturing fluid at a desired pressure. The method further includes discharging the pressurized fracturing fluid to the bore via the pump.

In yet another aspect of the present disclosure, a fracturing rig is provided. The fracturing rig includes a frame. The fracturing rig also includes a plurality of ground engaging members supported on the frame for moving the fracturing rig over a ground surface. The fracturing rig further includes a turbine mounted on the frame. The fracturing rig also includes a pump coupled to the turbine and supported on the frame. The pump includes a housing member configured to receive a fracturing fluid. The pump also includes an auger rotatably disposed within the housing member. The auger is configured to pressurize the fracturing fluid at a desired pressure based on a speed of the turbine to supply a pressurized fracturing fluid to a bore. The auger includes a shaft coupled to the turbine and rotatable about a rotational axis. The auger also includes a helical blade disposed around the shaft.

Other features and aspects of this disclosure will be apparent from the following description and the accompanying drawings.

### BRIEF DESCRIPTION OF THE DRAWINGS

FIG. 1 is a schematic view of a fracturing rig having a fracking system, according to an embodiment of the present disclosure;

FIG. 2 is a perspective view of a pump of the fracking system of FIG. 1, according to an embodiment of the present disclosure;

FIG. 3 is an exploded view of the pump of FIG. 2, according to an embodiment of the present disclosure;

FIG. 4 is a perspective view of an outlet member of the pump, according to an embodiment of the present disclosure; and

FIG. 5 is a flowchart of a method of fracturing a formation in a bore defined at a work site, according to an embodiment of the present disclosure.

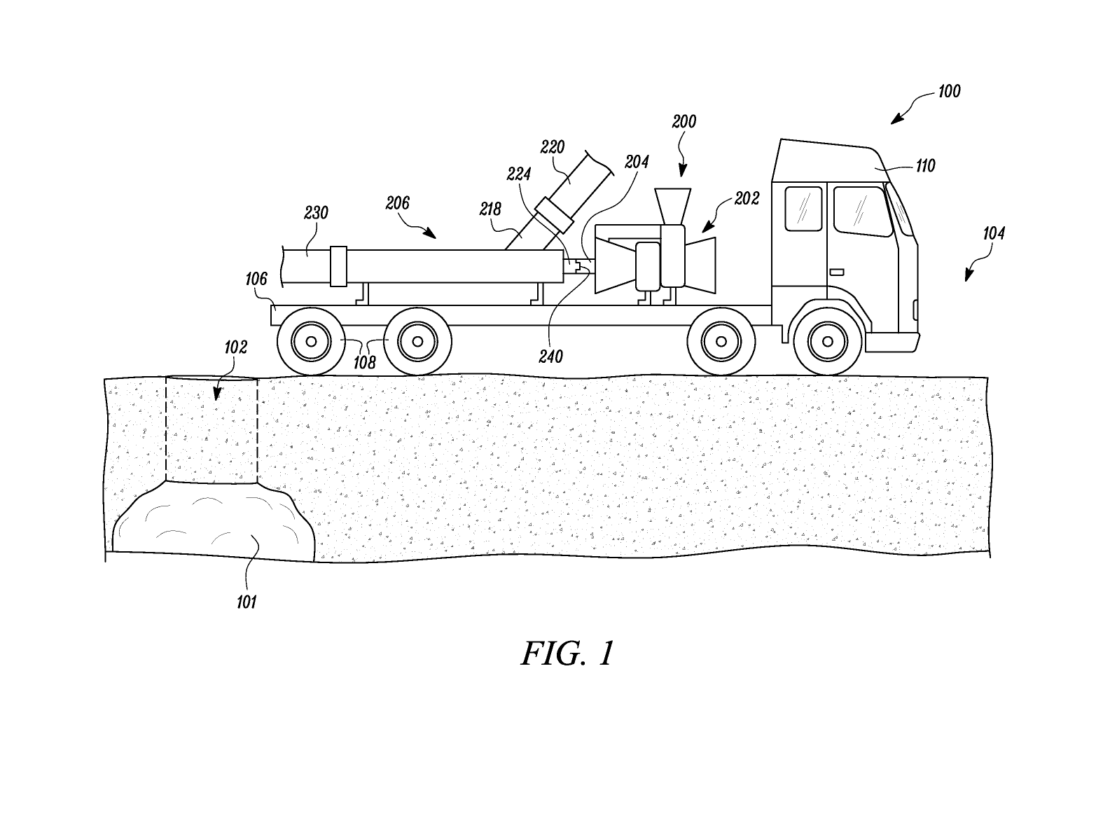

### DETAILED DESCRIPTION

Wherever possible, the same reference numbers will be used throughout the drawings to refer to the same or the like parts. In an embodiment, FIG. 1 illustrates a schematic view of a fracturing rig 100. The fracturing rig 100 is used for fracturing a formation 101 in a bore 102 defined at a worksite 104. In one example, the fracturing rig 100 may be utilized to hydraulically fracture the formation 101, such as a rock, to create a fracture in the formation 101. The fracture in the formation provides pathways for underground oil and gas deposits to flow from the formation 101 to a surface of the bore 102.

The fracturing rig 100 includes a frame 106. The fracturing rig 100 also includes a plurality of ground engaging members 108. The plurality of ground engaging members 108 includes wheels. In another example, the plurality of ground engaging members 108 may include tracks. The plurality of ground engaging members 108 propels the fracturing rig 100 on the worksite 104. A power source, such as an engine, may provide propulsion power for the ground engaging members 108 and may power a variety of other systems of the fracturing rig 100, including various mechanical, electrical, and hydraulic systems and/or components. Further, the fracturing rig 100 includes an operator control station 110. The operator control station 110 may include various operator controls and displays for operating the fracturing rig 100.

A fracking system 200 is mounted on the frame 106 of the fracturing rig 100. A schematic view of the fracking system 200 is shown in FIG. 1. The fracking system 200 is used for fracturing the formation 101 inside the bore 102. The fracking system 200 may also be referred as ‘the system 200’. The fracking system 200 may also be useful for displacement of any liquid slurry, such as dredged silt in a riverbed, evacuated sewage, or cement mixes and the like.

The fracking system 200 includes a turbine 202. The turbine 202 includes a rotor shaft 204 and a number of blades (not shown) mounted on the rotor shaft 204. A fluid, such as combustion elements, contacting the blades of the turbine 202 causes the blades to move and impart rotational energy to the rotor shaft 204. The turbine 202 is mounted on the frame 106 of the fracturing rig 100. In one example, the turbine 202 may be coupled to the frame 106 using mechanical fasteners, such as bolts and nuts.

The fracking system 200 includes a pump 206. The pump 206 is directly coupled to and driven by the turbine 202. The pump 206 may be mounted on the frame 106 using, for example, mechanical fasteners. In one example, the mechanical fasteners may include a bolt and a nut. The pump 206 increases a pressure of a fracturing fluid introduced in the pump 206 to a desired pressure. The desired pressure referred to herein is the pressure required to fracture the formation 101 in the bore 102. Further, the fracturing fluid may include at least one, or combination, of a fluid such as water, proppants, and chemicals. The proppants may include a solid material, such as sand or any other ceramic that is capable of keeping the fracture open during a fracking operation. Each constituent of the fracturing fluid may be stored in storage tanks (not shown) at the worksite 104. The constituents may be introduced in a blender (not shown) to uniformly mix the constituents and form a stream of fracturing fluid that is introduced in the pump 206.

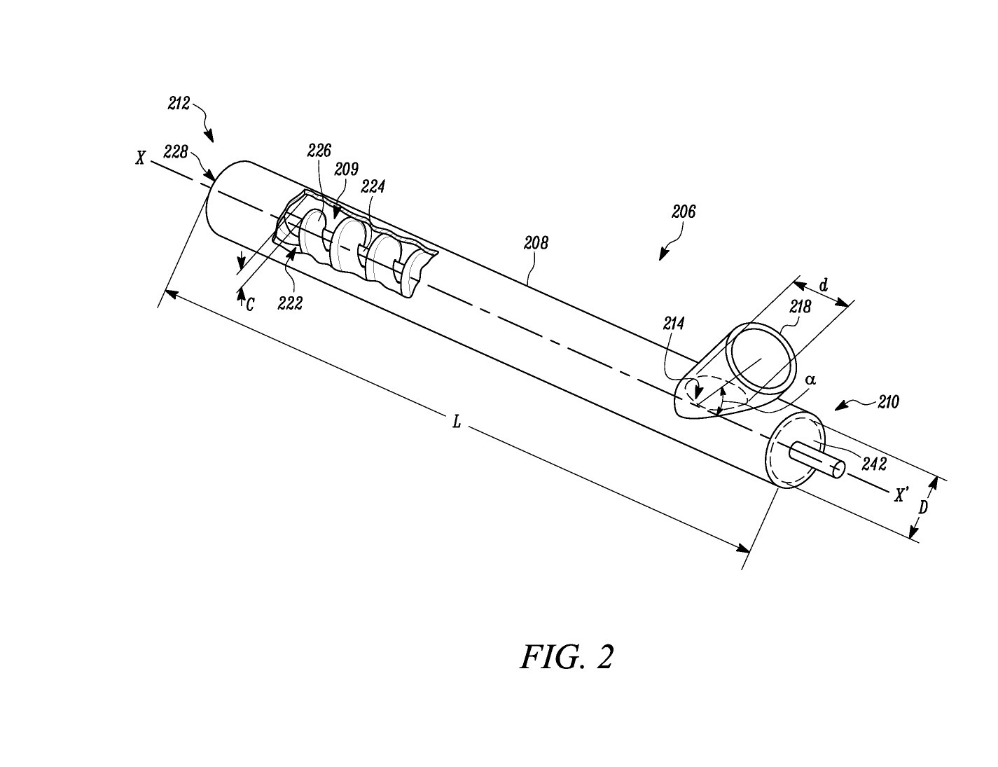

In an embodiment, FIG. 2 illustrates a perspective view of the pump 206 of the fracking system 200. The pump 206 includes a housing member 208. The housing member 208 defines a central axis X-X′. The housing member 208 has a circular cross section. The housing member 208 of the pump 206 receives the fracturing fluid from the blender. The housing member 208 includes a hollow portion 209. The hollow portion 209 of the housing member 208 defines an inner diameter “D”. In one example, the inner diameter “D” of the housing member 208 may be approximately between 90 millimeters (mm) to 115 mm. In another example, the diameter “D” of the housing member 208 may be approximately 100 mm

Further, a length “L” of the housing member 208 is greater than the inner diameter “D” of the housing member 208. In one example, the length “L” of the housing member 208 may be approximately between 800 mm and 1300 mm. In another example, the length “L” of the housing member 208 may be approximately equal to 1200 mm.

The housing member 208 includes a first end 210 and a second end 212. An inlet port 214 is defined on a wall of the housing member 208, adjacent to the first end 210 of the housing member 208. The inlet port 214 is embodied as a through-hole. The inlet port 214 receives and introduces the fracturing fluid in the housing member 208 of the pump 206. In one example, a diameter “d” of the inlet port 214 may be approximately between 90 mm to 110 mm. In another example, the diameter “d” of the inlet port 214 may be approximately equal to 100 mm

An inlet pipe 218 is coupled to the inlet port 214. The hollow portion 209 of the housing member 208 is in fluid communication with the blender via the inlet pipe 218 and a conduit 220 (shown in FIG. 1). The inlet pipe 218 is coupled to the housing member 208 at an angle of inclination “a” with respect to the central axis X-X′. In one example, the angle of inclination “a” may be approximately between 30° and 90° . In another example, the inclination “a” may be approximately equal to 45° . The inlet pipe 218 may be threadably coupled to the inlet port 214. In another example, the inlet pipe 218 may be bolted to the housing member 208. In yet another example, the inlet pipe 218 may be welded or integrally formed with the housing member 208, without any limitations.

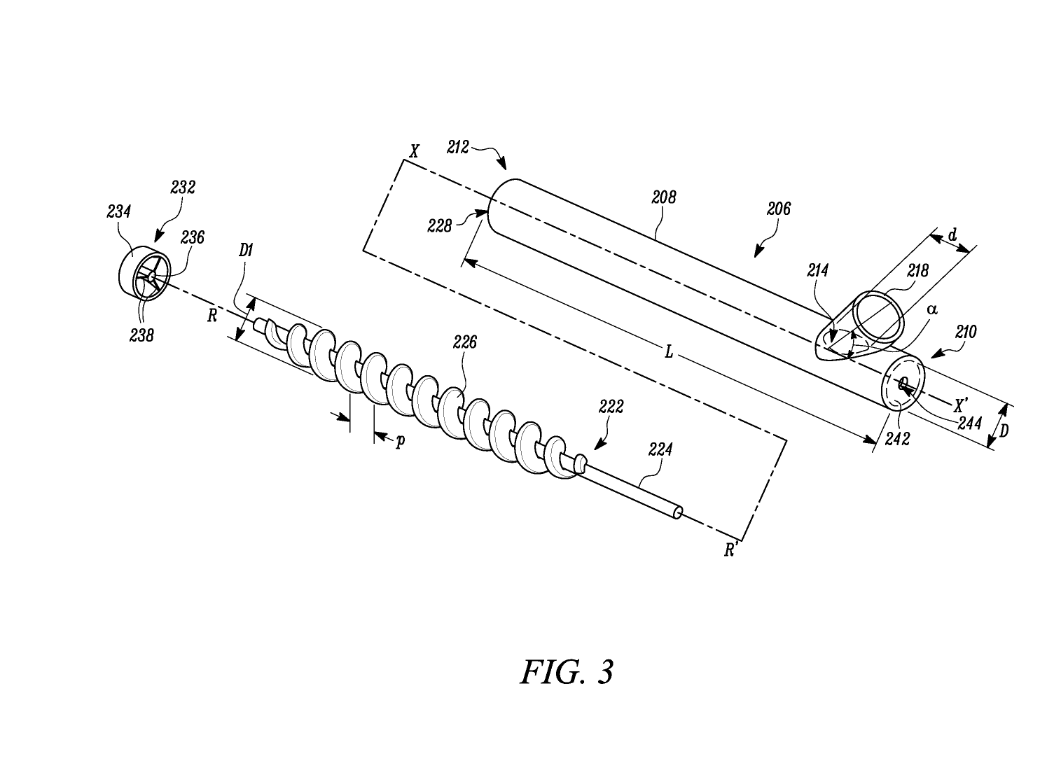

In an embodiment, FIG. 3 illustrates an exploded view of the pump 206. The pump 206 includes an auger 222. The auger 222 is rotatably disposed within the hollow portion 209 of the housing member 208. Based on a speed of the turbine 202, the auger 222 of the pump 206 pressurizes the fracturing fluid to the desired pressure. The auger 222 includes a shaft 224. The shaft 224 of the auger 222 is rotatable about a rotational axis R-R′. When the auger 222 is assembled with the housing member 208, the rotational axis R-R′ coincides with the central axis X-X′ of the housing member 208. The shaft 224 of the auger 222 is supported adjacent to the first end 210 of the pump 206 by a disc shaped member 242. The disc shaped member 242 includes a circular opening 244. A diameter of the circular opening 244 is greater than a diameter of the shaft 224 in order to receive and support the shaft 224. The circular opening 244 may have provision to provide bearing surface for supporting thrust loads against an increased portion of the diameter of the shaft 224. The bearing surface can be defined by any method known in the art. The increased portion of the shaft 224 can be integral to the shaft 224 or defined by affixing a ring to the shaft 224 or by any other method known in the art.

The shaft 224 of the auger 222 is directly coupled to the rotor shaft 204 of the turbine 202, such that the shaft 224 rotates at a rotational speed of the rotor shaft 204. The shaft 224 of the auger 222 is coaxial with the rotor shaft 204 of the turbine 202. Further, the shaft 224 is coupled to the rotor shaft 204 using a spline joint 240 (shown in FIG. 1). Alternatively, any other joint may be used to couple the shaft 224 with the rotor shaft 204, provided the shaft 224 runs at the rotational speed of the rotor shaft 204.

The auger 222 includes a helical blade 226 disposed around the shaft 224 of the auger 222. In one example, a pitch “p” of the helical blade 226 may be approximately between 60 mm to 100 mm. In another example, the pitch “p” of the helical blade 226 may be approximately equal to 80 mm. The helical blade 226 defines an outer diameter “D₁”. The outer diameter “D₁” of the helical blade 226 may be approximately between 80 mm and 98 mm. In one example, the outer diameter “D₁” of the helical blade 226 may be approximately equal to 95 mm.

The outer diameter “D₁” of the helical blade 226 is less than the inner diameter “D” of the hollow portion 209 of the housing member 208. More particularly, the outer diameter “D₁” defined by the helical blade 226 of the auger 222 and the inner diameter “D” of the housing member 208 define a radial clearance “C” therebetween (shown in FIG. 2). The radial clearance “C” may be approximately between 1 mm to 6 mm. In one example, the radial clearance “C” may be approximately equal to 2.5 mm.

Further, an outlet port 228 is defined adjacent to the second end 212 of the housing member 208. The pump 206 discharges a pressurized fracturing fluid through the outlet port 228. The outlet port 228 of the housing member 208 may be connected to an outlet pipe 230 (shown in FIG. 1). The outlet pipe 230 discharges the pressurized fracturing fluid to the bore 102.

An outlet member 232 is coupled to the outlet port 228 of the housing member 208. The outlet member 232 supports the shaft 224 of the auger 222 adjacent to the second end 212 of the pump 206. The outlet member 232 is coupled to the outlet port 228 of the housing member 208 using mechanical fasteners, such as bolts. Alternatively, the outlet member 232 may be threadably coupled to the housing member 208. In yet another example, the outlet member 232 may be welded, mechanically joined by compression, or integrally formed with the housing member 208.

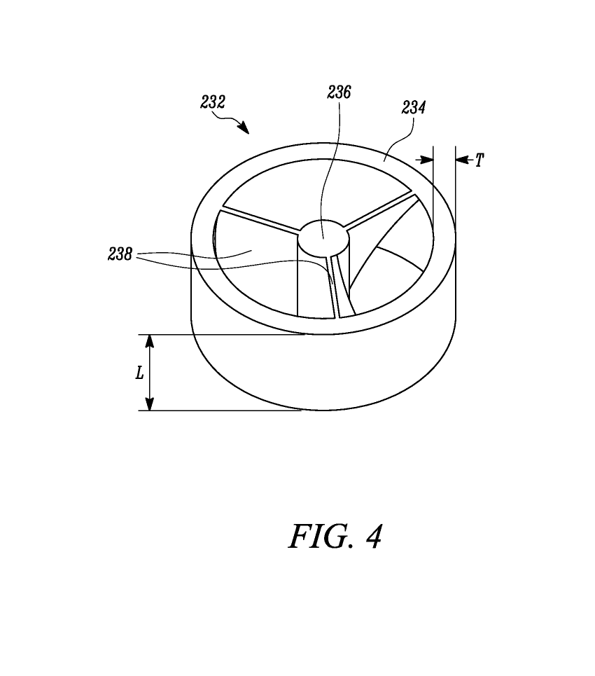

In an embodiment, FIG. 4 illustrates a perspective view of the outlet member 232. The outlet member 232 includes a ring body 234. The ring body 234 has a circular cross section. Further, a thickness “T” of the ring body 234 is equal to a thickness of the housing member 208. In one example, the ring body 234 has a length “1” defined along the central axis X-X′ of the housing member 208. The length “1” may be approximately between 35 mm to 65 mm. In one example, the length “1” may be approximately equal to 50 mm.

The outlet member 232 includes a central ring 236. The central ring 236 is embodied as a hollow cylindrical member. The central ring 236 is coaxial to the shaft 224 of the auger 222. The central ring 236 is coupled with the shaft 224 of the auger 222. More particularly, the shaft 224 is supported adjacent to the second end 212 of the pump 206 by the central ring 236. Further, the outlet member 232 includes a plurality of supporting webs 238. The webs 238 extend radially between the ring body 234 and the central ring 236. In one example, the webs 238 of the outlet member 232 are twisted by an angle of approximately 30° with respect to the central axis X-X′ of the housing member 208. In the illustrated embodiment, the outlet member 232 includes three webs 238. However, the plurality of webs 238 may vary based on dimensions of the pump 206, such as the inner diameter “D” of the hollow portion 209 of the housing member 208.

The outlet member 232 may be manufactured by any known additive or subtractive manufacturing process known in the art. In one example, the ring body 234, the central ring 236, and the webs 238 may be separate cast components that may be mechanically coupled to each other to form the outlet member 232. Alternatively, the ring body 234, the central ring 236, and the webs 238 may be formed as an integral unit using a manufacturing process, such as a molding process or a casting process, without any limitations.

Referring to FIGS. 1, 2, and 3, an operation of the turbine 202 causes the auger 222 of the pump 206 to rotate at the rotational speed of the rotor shaft 204. As the auger 222 rotates, the fracturing fluid is pushed by the helical blade 226 towards the outlet port 228, along the central axis X-X′. As the fracturing fluid flows through the housing member 208 and approaches a filled state in the bore 102, the pressure of the fracturing fluid increases. The pressure of the fracturing fluid exiting the pump 206 is compared to the desired pressure. In one exemplary embodiment, a sensing unit may be positioned close to the outlet port 228 of the pump 206. The sensing unit may determine the pressure of the fracturing fluid exiting the pump 206. Based on the determined pressure, the speed of the turbine 202, and thereby the speed of the auger 222 may be controlled. Thus the pressure of the fracturing fluid exiting the pump 206 may be controlled to match the desired pressure within a threshold. In another example, pumping of the fracturing fluid may continue until a pressure of the fracturing fluid reaches to a peak level and then decrease, indicating the fracture in the formation 101.

The pressurized fracturing fluid is introduced by the pump 206 in the bore 102, via the outlet pipe 230. As a flow of the pressurized fracturing fluid is restricted inside the bore 102, a pressure inside the bore 102 increases. When the pressure inside the bore 102 increases beyond the formation's threshold, cracks are developed in the formation 101. Further increase in the pressure inside the bore 102 causes the cracks to widen, thereby allowing release of oil or gases from the formation 101.

### INDUSTRIAL APPLICABILITY

In an embodiment, the fracking system 200 for fracturing the formation 101 disclosed above is a dual component system including the turbine 202 and the pump 206. The pump 206 of the fracking system 200 includes the auger 222 located within the housing member 208, such that the radial clearance “C” is defined between the auger 222 and the housing member 208. Provision of the radial clearance “C” almost eliminates wear and tear of the helical blade 226 or the housing member 208, during the operation of the auger 222, greatly increasing the overall durability of the system and reduces cost associated with the system. Further, as the fracking system 200 includes the turbine 202 instead of a conventional diesel engine, the requirement of an aftertreatment system for treating of exhaust gases and cooling system are eliminated.

The fracking system 200 described herein includes far fewer components compared to known fracking system, and includes components that have a longer service life, therefore the fracking system 200 provides a cost effective solution for fracturing the formations 101. Also, due to longer service life of the components of the fracking system 200, downtime of the fracturing rig 100 for replacement purposes is reduced. The components of the fracking system 200 are durable and flexible in operation, and can be accommodated in a compact space. Further, the components of the fracking system 200 are light in weight and simple to control.

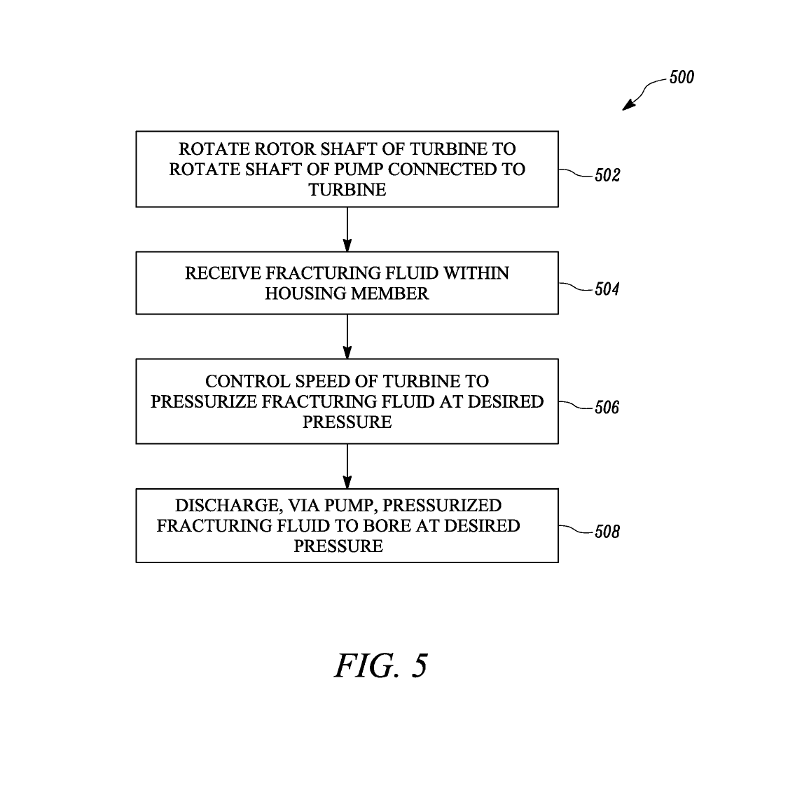

In an embodiment, FIG. 5 illustrates a flow chart of a method 500 for fracturing the formation 101 in the bore 102 defined at the worksite 104. At block 502, the method 500 includes rotating the rotor shaft 204 of the turbine 202 to rotate the shaft 224 of the pump 206. The pump 206 includes the housing member 208 and the auger 222 rotatably disposed within the housing member 208. Specifically, the rotor shaft 204 of the turbine 202 is coupled with the shaft 224 of the auger 222 via the spline joint 240. The rotor shaft 204 and the shaft 224 of the auger 222 are coaxial. Thus, the rotor shaft 204 of the turbine 202 and the shaft 224 of the pump 206 may be rotated at same speed. Further, the outlet member 232 is disposed at the outlet port 228 of the housing member 208 for supporting the shaft 224 of the auger 222. The outlet member 232 includes the ring body 234 coupled to the housing member 208. The outlet member 232 also includes the central ring 236 coupled to the shaft 224 of the auger 222. The outlet member 232 further includes the plurality of webs 238 extending between the ring body 234 and the central ring 236.

At block 504, the fracturing fluid is received within the housing member 208. The fracturing fluid is communicated to the housing member 208 of the pump 206 via the conduit 220. At block 506, the speed of the turbine 202 is controlled to pressurize the fracturing fluid at the desired pressure. In an example, the speed of the turbine 202 may be controlled based on the feedback received from the sensing unit. In another example, the fracking system 200 may include a controller in communication with the turbine 202 and the pump 206. The controller may be configured to control the speed of the engine based on a pressure of the fracturing fluid required for forming the fracture in the formation 101. At block 508, the pressurized fracturing fluid is discharged to the bore 102 at the desired pressure, via the outlet pipe 230.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for fracturing a formation in a bore at a worksite comprising:
a turbine; and
a pump coupled to the turbine, the pump comprising:
a housing member configured to receive a fracturing fluid; and
an auger rotatably disposed within the housing member, the auger being configured to pressurize the fracturing fluid at a desired pressure based on a speed of the turbine to supply a pressurized fracturing fluid to the bore, the auger comprising:
a shaft coupled to the turbine and rotatable about a rotational axis, and
a helical blade disposed around the shaft.

2. The system of claim 1, wherein the turbine comprises a rotor shaft coupled to the shaft of the auger, and wherein the rotor shaft and the shaft of the auger are coaxial.

3. The system of claim 2, wherein the rotor shaft is coupled to the shaft of the auger by a spline joint.

4. The system of claim 1, wherein the housing member comprises a hollow portion defining an inner diameter, and wherein the helical blade defines an outer diameter less than the inner diameter of the hollow portion of the housing member.

5. The system of claim 4, wherein the inner diameter of the housing member and the outer diameter of the auger define a radial clearance therebetween.

6. The system of claim 1, wherein the pump comprises an inlet pipe coupled to an inlet port of the housing member to receive the fracturing fluid therethrough, and wherein the inlet pipe is disposed at an angle of inclination with respect to a central axis of the housing member.

7. The system of claim 1, wherein the pump comprises an outlet member coupled to an outlet port of the housing member, the outlet member comprising:
a ring body configured to couple to the housing member;
a central ring coaxial to the shaft of the auger; and
a plurality of webs extending between the ring body and the central ring.

8. The system of claim 7, wherein the shaft of the auger is supported by the central ring of the outlet member.

9. A method for fracturing a formation in a bore defined at a worksite, the method comprising:
rotating a rotor shaft of a turbine to rotate a shaft of a pump connected to the turbine, wherein the pump comprises a housing member and an auger rotatably disposed within the housing member;
receiving a fracturing fluid within the housing member;
controlling a speed of the turbine to pressurize the fracturing fluid at a desired pressure; and
discharging, via the pump, the pressurized fracturing fluid to the bore at the desired pressure.

10. The method of claim 9 further comprising, disposing an outlet member at an outlet port of the housing member for supporting the shaft of the auger, wherein the outlet member comprises:
a ring body configured to couple to the housing member;
a central ring coupled to the shaft of the auger; and
a plurality of webs extending between the ring body and the central ring.

11. The method of claim 10 further comprising, coupling the rotor shaft of the turbine with the shaft of the auger via a spline joint, wherein the rotor shaft and the shaft of the auger are coaxial.

12. A fracturing rig comprising:
a frame;
a plurality of ground engaging members supported on the frame for moving the fracturing rig over a ground surface;
a turbine mounted on the frame; and
a pump coupled to the turbine and supported on the frame, the pump comprising:
a housing member configured to receive a fracturing fluid; and
an auger rotatably disposed within the housing member, the auger being configured to pressurize the fracturing fluid at a desired pressure based on a speed of the turbine to supply a pressurized fracturing fluid to a bore, the auger comprising:
a shaft coupled to the turbine and rotatable about a rotational axis; and
a helical blade disposed around the shaft.

13. The fracturing rig of claim 12, wherein the turbine comprises a rotor shaft coupled to the shaft of the auger, and wherein the rotor shaft and the shaft of the auger are coaxial.

14. The fracturing rig of claim 13, wherein the rotor shaft is coupled to the shaft of the auger by a spline joint.

15. The fracturing rig of claim 12, wherein the housing member comprises a hollow portion defining an inner diameter, and wherein the helical blade defines an outer diameter less than the inner diameter of the hollow portion of the housing member.

16. The fracturing rig of claim 15, wherein the inner diameter of the housing member and the outer diameter of the auger define a radial clearance therebetween.

17. The fracturing rig of claim 12, wherein the pump comprises an inlet pipe coupled to an inlet port of the housing member to receive the fracturing fluid therethrough, and wherein the inlet pipe is disposed at an angle of inclination with respect to a central axis of the housing member.

18. The fracturing rig of claim 12, wherein the pump comprises an outlet member coupled to an outlet port of the housing member, the outlet member comprising:
a ring body configured to couple to the housing member;
a central ring coaxial to the shaft of the auger; and
a plurality of webs extending between the ring body and the central ring.

19. The fracturing rig of claim 18, wherein the shaft of the auger is supported by the central ring of the outlet member.

20. The fracturing rig of claim 18 further comprising an outlet pipe coupled to the outlet member of the pump, the outlet pipe being configured to discharge the pressurized fracturing fluid to the bore.
